(19) United States
(12) Patent Application Publication
(10) Pub. No.: US 2003/0165414 A1
(43) Pub. Date: Sep. 4, 2003

(54) Exhaust treatment apparatus containing catalyst members having electric arc sprayed substrates and methods of using the same

(76) Inventors: Michael P. Galligan, Clark, NJ (US); Albert K. Bond, Simpsonville, SC (US); Joseph C. Dettling, Howell, NJ (US)

Correspondence Address: Engelhard Corporation, 101 Wood Avenue, P.O. Box 770, Iselin, NJ, 08830, US

(21) Appl. No.: 10/376,782

(22) Filed: Feb. 28, 2003

Related U.S. Application Data
(63) Continuation of application No. 09/071,663, filed on May 1, 1998, now abandoned.

(51) Int. Cl. B01D 53/92

(52) U.S. Cl. 423/213.2; 502/302

(57) ABSTRACT

Electric arc spraying a metal onto a substrate produces an anchor layer on the substrate that serves as a surprisingly superior intermediate layer for a catalytic material deposited thereon. Spalling of catalytic material is resisted even when subjected to the harsh conditions imposed by small engines or in a close-coupled position for a larger engine.

### BACKGROUND OF THE INVENTION

1. Field of the Invention

The present invention relates to catalyzed substrates, that is, to catalyst members comprising a substrate on which is coated a catalytic material, and to methods of making such catalyzed substrates. More particularly, the present invention relates to catalyzed substrates comprising a substrate which is coated with a metal anchor layer in order to enhance the adherence of a catalytic material to the substrate or to facilitate mounting the catalyst member in a canister.

2. Related Art

U.S. Pat. No. 5,204,302, issued Apr. 20, 1993 to I. V. Gorynin et al, is entitled “Catalyst Composition and a Method For Its Preparation” and is hereinbelow referred to as “the '302 Patent”. The '302 Patent discloses a multi-layered catalyst material supported on a metal substrate. The metal substrate (column 4, lines 64-68) may be any thermally stable metal including stainless steel and low alloy steel, the '302 Patent stating that, regardless of which type of substrate is used, there is no appreciable difference in the performance of the bonded layers. As illustrated in FIG. 1 of the Patent and described at column 4, line 32 et seq, a flame spraying or plasma spraying apparatus (FIG. 2 and column 5, line 32 et seq) is used to apply an adhesive sublayer 12 to metal substrate 11. Adhesive sublayer 12 contains a self-bonding intermetallic compound formed from any one of a number of metal pairings, including aluminum and nickel, as described at column 5, lines 1-6 of the '302 Patent. The high temperature of the flame or plasma spray operation is said to generate a diffusion layer (13 in FIG. 1) caused by diffusion of material of substrate 11 and sublayer 12 across their interface (column 4, lines 37-41). A catalytically active layer 14 (FIG. 1) is sprayed atop the sublayer 12 and has a gradient composition with an increasing content of catalytically active material as one proceeds away from the interface (column 5, lines 7-24). The catalytically active layer can be alumina, preferably gamma-alumina, and may further include specified metal oxide stabilizers such as CaO, Cr₂O₃, etc., and metal oxide catalytic materials such as ZrO₂, Ce₂O₃, etc. A porous layer 18 (FIG. 1 and column 5, lines 25-32) contains some catalytically active components and transition metal oxides as decomposition products of pore forming compounds such as MnCO₃, Na₂CO₃, etc., which presumably form pores as gases evolve from the carbonates or hydroxides (column 7, lines 40-45) as they thermally decompose (see column 7, lines 37-45). As described at column 5, line 44 et seq and at column 7, line 37 et seq, sublayer 12, catalytically active layer 14 and porous layer 18 may be applied by a continuous plasma spray operation in which different ones of the powders 21, 28 and 33 (FIG. 2) are fed into the plasma spray in a preselected sequence and at preselected intervals. An optional activator coating 19 may be applied onto the porous layer, preferably by magnetron sputtering (see column 4, lines 56-63 and column 8, lines 24 et seq).

U.S. Pat. No. 4,027,367, issued Jun. 7, 1977 to H. S. Rondeau, which is incorporated herein by reference, is entitled “Spray Bonding of Nickel Aluminum and Nickel Titanium Alloys” and is hereinbelow referred to as “the '367 Patent”. The '367 Patent discloses a method of electric arc spraying of self-bonding materials, specifically, nickel aluminum alloys or nickel titanium alloys, by feeding metal constituent wires into an electric arc spray gun (column 1, lines 6-13). The '367 Patent mentions, starting at column 1, line 25, combustion flame spray guns, e.g., guns feeding a mixture of oxygen and acetylene to melt a powder fed into the flame. Such combustion flame spray guns are said to operate at relatively low temperature and are often incapable of spraying materials having melting points exceeding 5,000° F. (2,760° C.). The '367 Patent also mentions (starting at column 1, line 32) that plasma arc spray guns are the most expensive type of thermal spray devices and produce much higher temperatures than combustion-type flame spray guns, up to approximately 30,000° F. (16,649° C.). It is further pointed out in the '367 Patent that plasma arc spray guns require a source of inert gas for the creation of plasma as well as extremely accurate control of gas flow rate and electric power for proper operation. In contrast, starting at column 1, line 39, electric arc spray guns are stated to simply require a source of electric power and a supply of compressed air or other gas to atomize and propel the melted material in the arc to the substrate or target. The use of electric arc spraying with a wire feed of nickel aluminum or nickel titanium alloys onto suitable substrates, including steel and aluminum substrates is exemplified starting at column 5, line 28.

U.S. Pat. No. 3,111,396 to Ball, dated Nov. 19, 1963 (hereinafter referred to as “the '396 Patent”), discloses a method for making a porous metal material or “metal foam”. Essentially, the method comprises forming a porous organic structure, impregnating the structure with a fluid suspension of powdered metal in a liquid vehicle, and drying and heating the impregnated structure to remove the liquid vehicle and then further heating the organic structure to decompose it and to sinter the metal powder into a continuous form. The resulting metallic structure, while not foamed during the manufacturing process, is nevertheless described as foamed because its ultimate structure resembles that of a foamed material.

SAE (Society of Automotive Engineers) Technical Paper 971032, entitled A New Catalyst Support Structure For Automotive Catalytic Converters by Arun D. Jatkar, was presented at the International Congress and Exposition, Detroit, Mich., Feb. 24-27, 1997. This Paper discloses the use of metal foams as a substrate for automotive catalysts. The Paper describes the use of various metal foams as catalyst substrates and notes that foams made of pure nickel or nickel-chromium alloys were not successful as substrates for automotive catalysts because of corrosion problems encountered in the environment of an automotive exhaust catalyst. Metal foams made from Fecralloy and ALFA-IV® ferritic stainless steel powders were said to be successful, at least in preliminary tests, for use as substrates for automotive catalysts. A ceramic washcoat having a precious metal loading was deposited onto disks of ALFA-IV® metal foam produced by Astro Met, Inc. The washcoat comprised gamma-alumina and cerium oxide on which platinum and rhodium in a ratio of 4:1 were dispersed to provide a loading of 40 grams of the precious metal per cubic foot of the foam-supported catalyst. Such catalyzed substrates were said to be effective in treating hydrocarbon emissions.

In an article entitled “Catalysts Based On Foam Metals”, published in Journal of Advanced Materials, 1994, 1(5) 471-476, Pestryakov et al suggest the use of foamed metal as a carrier substrate for catalytic materials for the catalytic neutralization of exhaust gases of car engines. The use of an intermediate layer of high surface area alumina between the metallic foam and the catalytic material is recommended, by direct deposition on the foam carrier. In addition to increasing the surface area of the substrate, the alumina is also credited with protecting the surface of the substrate against corrosion.

SAE Paper 962473 by Reck et al of EMITECH, GmbH, entitled “Metallic Substrates and Hot Tubes For Catalytic Converters in Passenger Cars, Two-and Three-Wheelers”, addresses the use of catalytic converters and hot tubes to treat the exhaust of scooters and motorcycles, especially those having two-stroke engines.

Prior art attempts to adhere catalytic materials to metallic substrates include the use of ferrous alloys containing aluminum. The alloy is formed into a substrate structure and is heat-treated under oxidizing conditions. The aluminum oxidizes, forming whiskers of alumina that project from the substrate surface and are believed to provide anchors for catalytic materials. The use of other alloying elements, e.g., hafnium, in ferrous metals for this purpose is known to provide such whiskers upon oxidizing treatment.

### SUMMARY OF THE INVENTION

The present invention relates to the use of electric arc spraying of metal onto various substrates for use in preparing catalyst members.

One aspect of the present invention relates to a catalyst member comprising a carrier substrate having an anchor layer disposed thereon by electric arc spraying and catalytic material disposed on the carrier substrate.

According to one aspect of the invention, the anchor layer may be deposited by electric arc spraying a metal feedstock selected from the group consisting of nickel, Ni/Cr/Al/Y, Co/Cr/Al/Y, Fe/Cr/Al/Y, Co/Ni/Cr/Al/Y, Fe/Ni/Cr, Fe/Cr/Al, Ni/Cr, Ni/Al, 300 series stainless steels, 400 series stainless steels, Fe/Cr and Co/Cr, and mixtures of two or more thereof. In one embodiment, the anchor layer may comprise nickel and aluminum. The aluminum may comprise from about 3 to 10 percent, optionally from about 4 to 6 percent, of the combined weight of nickel and aluminum in the anchor layer.

According to another aspect of the invention, the catalytic material may be deposited on the anchor layer. It may comprise a refractory metal oxide support on which one or more catalytic metal components are dispersed.

Optionally, the substrate may comprise at least two regions of different density which may have different effective loadings of catalytic material thereon. The two regions may comprise foamed metal, wire mesh and/or corrugated foil honeycomb substrates.

An exhaust treatment apparatus may comprise a catalyst member as described herein connected in the exhaust flow path of an internal combustion engine. In one type of embodiment, the substrate of the catalyst member may comprise the interior surface of a conduit through which the exhaust of an internal combustion engine is flowed prior to discharge of the exhaust.

The carrier substrate in a catalyst member according to the present invention may comprise a metal substrate or ceramic substrate or a combination of the two.

This invention also provides a method for manufacturing a catalyst member. The method comprises depositing by electric arc spraying a metal feedstock onto a substrate to provide a metal anchor layer on the substrate, and depositing a catalytic material onto the substrate. Optionally, the catalytic material may be deposited by means other than electric arc spraying. Depositing the catalytic material may comprise coating the metal anchor layer with a catalytic material comprising a refractory metal oxide support on which one or more catalytic components are dispersed. Optionally, the method may comprise electric arc spraying a molten metal feedstock at a temperature that permits the molten metal to freeze into an irregular surface configuration upon impinging on the substrate surface, for example, electric arc spraying the molten metal at an arc temperature of not more than about 10,000° F.

Another method provided by this invention relates to a method for manufacturing a catalyst member comprising electric arc spraying a metal feedstock onto at least one substrate to provide at least one anchor layer-coated substrate, depositing onto the at least one anchor layer-coated substrate a catalytic material comprised of a bulk refractory metal oxide having dispersed thereon one or more catalytically active components to provide at least one catalyzed substrate and incorporating the at least one catalyzed substrate into a body configured to define an inlet opening and an outlet opening and so configuring and disposing the at least one catalyzed substrate between the inlet and outlet openings to define a plurality of fluid flow paths therebetween.

This invention may therefore provide an exhaust treatment apparatus comprising a catalyzed substrate comprising a metal substrate defining a plurality of fluid flow passages therethrough and having thereon an anchor layer electric arc sprayed thereon. There may be a catalytic material disposed on the anchor layer, the catalytic material comprising a bulk refractory metal oxide having dispersed thereon one or more catalytically active metal components. The catalyzed substrate may be enclosed in a canister having an inlet opening and an outlet opening and disposed between the inlet and outlet openings, whereby at least some of a fluid flowing through the canister between the inlet and outlet openings thereof is constrained to follow the fluid flow paths and thereby contact the catalyzed metal substrate. The catalyzed metal substrate may be configured and positioned within the canister whereby substantially all of a fluid flowing through the canister between the inlet and outlet openings thereof is constrained to follow the fluid flow paths and thereby contact the catalyzed metal substrate.

The invention also provides a method for treating an engine exhaust stream by flowing the exhaust stream in contact with a catalyst member as described herein.

### BRIEF DESCRIPTION OF THE DRAWINGS

FIGS. 1A-1D are photomicrographs of a foamed metal substrate without an anchor layer deposited thereon, at magnifications of 38×, 55×, 152× and 436×, respectively;

FIGS. 2A-2D are photomicrographs of a foamed metal substrate having an anchor layer electric arc sprayed thereon, at magnifications of 38×, 55×, 153× and 434×, respectively;

FIGS. 2E-2G are photomicrographs of a cross section of a flat metal substrate and an anchor layer electric arc sprayed thereon, at magnifications of 500×, 1.51 k× and 2.98 k×.

FIG. 2H is an elevation view of a perforated, tubular metal substrate;

FIG. 2I is an elevation view of a catalyst member in accordance with the present invention comprising the substrate of FIG. 2H;

FIG. 2J is a schematic view of a wire mesh substrate having an anchor layer sprayed thereon in accordance with the present invention;

FIG. 3A is a schematic cross-sectional view of a metal substrate having an anchor layer electric arc sprayed thereon according to one embodiment of the present invention;

FIG. 3B is a schematic cross-sectional view of the substrate of FIG. 3A after processing into a corrugated configuration and being disposed upon another sprayed substrate;

FIG. 3C is a schematic cross-sectional view of the substrates of FIG. 1B after further processing to wind the substrates to form a honeycomb;

FIG. 3D is a schematic process diagram illustrating the manufacture of a catalyst member according to a particular embodiment of the present invention;

FIG. 4A is a schematic cross-sectional view of a muffler for a small engine containing an exhaust gas treatment apparatus that comprises a catalyst member according to one embodiment of the present invention;

FIG. 4B is a view of portion A of the apparatus of FIG. 4A;

FIG. 5 is a perspective view of a ceramic honeycomb substrate having an anchor layer deposited on the smooth outer surface thereof according to another embodiment of the invention; and

FIG. 6 is a schematic cross-sectional view of an exhaust gas treatment apparatus including two foamed metal regions of different densities according to the present invention.

### DETAILED DESCRIPTION OF THE INVENTION AND PREFERRED EMBODIMENTS THEREOF

One broad aspect of this invention pertains to the utilization of thermal spraying to apply a metal anchor layer onto a substrate having an open structure, i.e., “open substrates”. Open substrates are configured to define apertures, pores, channels or other structural features that significantly increase the surface area of the substrate and permit the flow of liquids and gases therethrough, in contrast to the closed substrates such as plates, tubes, foils and the like that have relatively small surface area and that are not adapted for fluid flow through the surface of the substrate and which serve more like barriers than flow-through structures. Open substrates may be provided in a variety of forms and configurations, including woven or non-woven mesh, wadded fibers, foamed, reticulated, etc. Since these structures have higher surface areas than barrier-type substrates and since they permit fluid flow therethrough, they are well-suited for use in preparing catalyst members for the catalytic treatment of liquid- or gas-borne materials. This broad aspect of the present invention pertains to thermal spraying processes in general, including plasma spraying, electric arc spraying, etc., which have not previously been utilized for open substrates.

Another aspect of the present invention arises from a discovery that electric arc spraying, e.g., wire arc spraying, of a metal (which term, as used herein and in the claims, includes mixtures of metals, including without limitation, metal alloys, pseudoalloys, and other intermetallic combinations) onto a metal or ceramic substrate yields a structure having unexpectedly superior utility as a carrier for catalytic materials in the field of catalyst members. Electric wire arc spraying is a known process, as indicated by the above reference to U.S. Pat. No. 4,027,367 which is incorporated herein by reference. Briefly described, in the wire arc spray process, two feedstock wires act as two consumable electrodes. These wires are insulated from each other as they are fed to the spray nozzle of a spray gun in a fashion similar to wire flame guns. In the nozzle, the wires meet in the center of a gas stream. An arc of about 18 to 40 volts is initiated between the wires, causing the tips of the wires to melt. An atomizing gas, usually compressed air, is directed across the arc zone, shearing off the molten droplets to form a spray that is propelled onto the substrate. Only metal wire feedstock can be used in an arc spray system because the feedstock must be conductive. The high particle temperatures created by the spray gun produce minute weld zones at the impact point on a metallic substrate. As a result, arc spray coatings (sometimes referred to herein as “anchor layers”) have good cohesive strength and a very good adhesive bond to the substrate. Arc spray coatings are usually harder to finish and normally have higher spray rates than coatings of other thermal spray processes. Dissimilar electrode wires can be used to create an anchor layer containing a mixture of two or more different metal materials, referred to as a “pseudoalloy”. Optionally, reactive gases can be used to atomize the molten feedstock to effect changes in the composition or properties of the applied anchor layer. On the other hand, it may be advantageous to employ an inert gas or at least a gas that does not contain oxygen or another oxidizing species. Oxygen, for example, may cause oxidation on the surface of a metal substrate or in the feedstock material and thus weaken the bond between the anchor layer and the substrate.

One aspect of the present invention derives from the discovery that electric arc spraying a metal onto a metal substrate forms an anchor layer on the substrate and that it provides an unexpectedly superior carrier for catalytic materials, which have been seen to adhere to such a carrier better than to a carrier comprising a substrate having an intermediate metal layer deposited thereon by plasma spraying, or on a carrier comprising a substrate without an intermediate layer applied thereto. Before the present invention, catalytic materials disposed on metal substrates, with or without intermediate layers, often did not adhere sufficiently well to the substrate to provide a commercially acceptable product. For example, a metal substrate having a metal intermediate layer that was plasma-sprayed thereon and having a catalytic material applied to the intermediate layer failed to retain the catalytic material, which flaked off upon routine handling, apparently due to a failure of the intermediate layer to bond with the substrate. The catalytic material on other carriers was seen to spall off upon normal use, apparently as a result of being subjected to a high gas flow rate, to thermal cycling, to the eroding contact of high temperature steam and other components of the exhaust gas stream, vibrations, etc. The present invention therefore improves the durability of catalyst members comprising catalytic materials carried on carrier substrates by improving their durability. It also permits the use of such catalyst members in positions upstream from sensitive equipment like turbochargers that would be damaged by catalytic material and/or anchor layer material that spall off prior art catalyst members.

Surprisingly, the Applicants have discovered that electric arc spraying, of which wire arc spraying is a particular embodiment, of a metal onto a metal substrate results in a superior bond between the resulting anchor layer and the substrate relative to plasma spraying. An electric arc sprayed anchor layer is believed to have at least two characteristics that distinguish it from anchor layers applied by plasma spraying: a superior anchor layer-metallic substrate interface bond and a highly irregular or “rough” surface. It is believed that the anchor layer-metallic substrate interface bond may be the result of diffusion between the sprayed material and the metallic substrate that is achieved at their interface despite the relatively low temperature at which wire arc spraying is practiced. For example, the electric arc temperature may be not more than 10,000° F. In such case, the temperature of the molten feedstock is expected to be at a temperature of not more than about 5000° F., preferably in the range of 1000° to 4000° F., more preferably not more than about 2000° F. The low temperature is also believed to be responsible for the especially uneven surface of the anchor layer because the sprayed material cools on the substrate (whether metal or ceramic) to its freezing temperature so quickly that it does not flow significantly on the substrate surface and therefore does not smooth out. Instead, it freezes into an irregular surface configuration. Accordingly, the surface of the anchor layer has a rough profile that provides a superior physical anchor for catalytic components and materials disposed thereon. An electric arc spray process can be used to produce an anchor layer on a variety of substrates that may vary by their composition and/or by their physical configuration. For example, the substrate may be in the form of metal plates, foil, wire, wire mesh, foamed metal, etc., ceramic, or a combination of two or more thereof. It does not appear to be important to match the sprayed metal to the metal of the substrate.

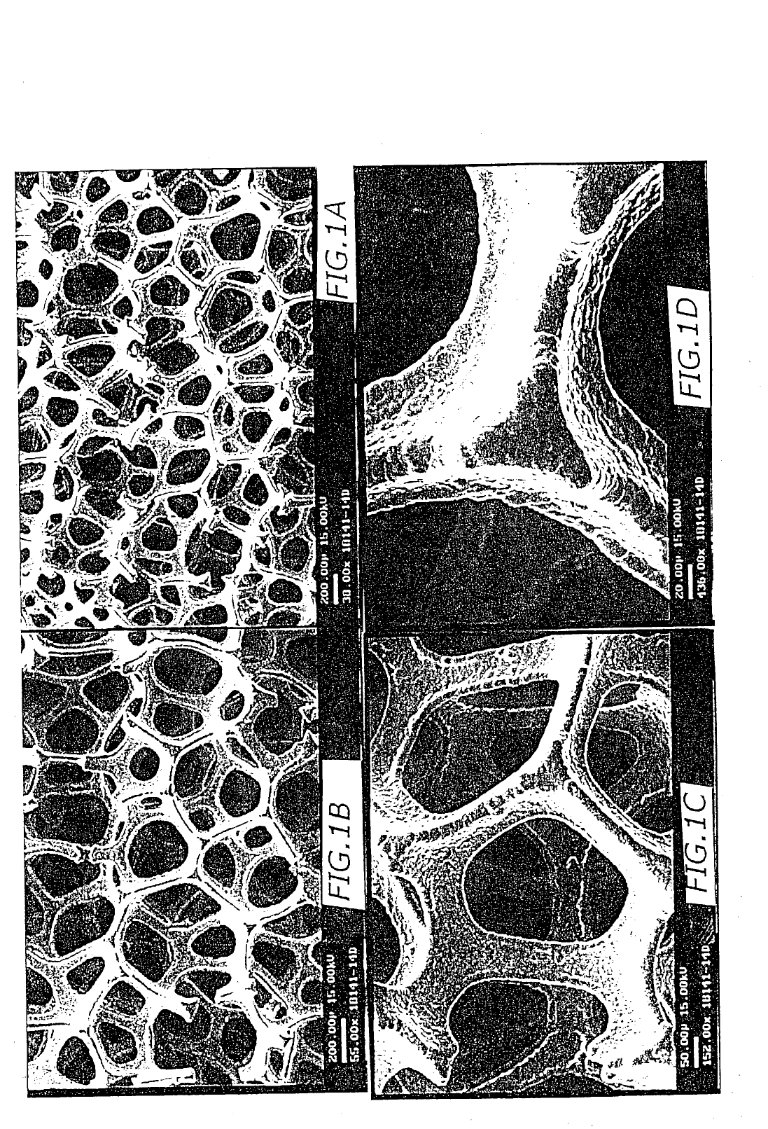

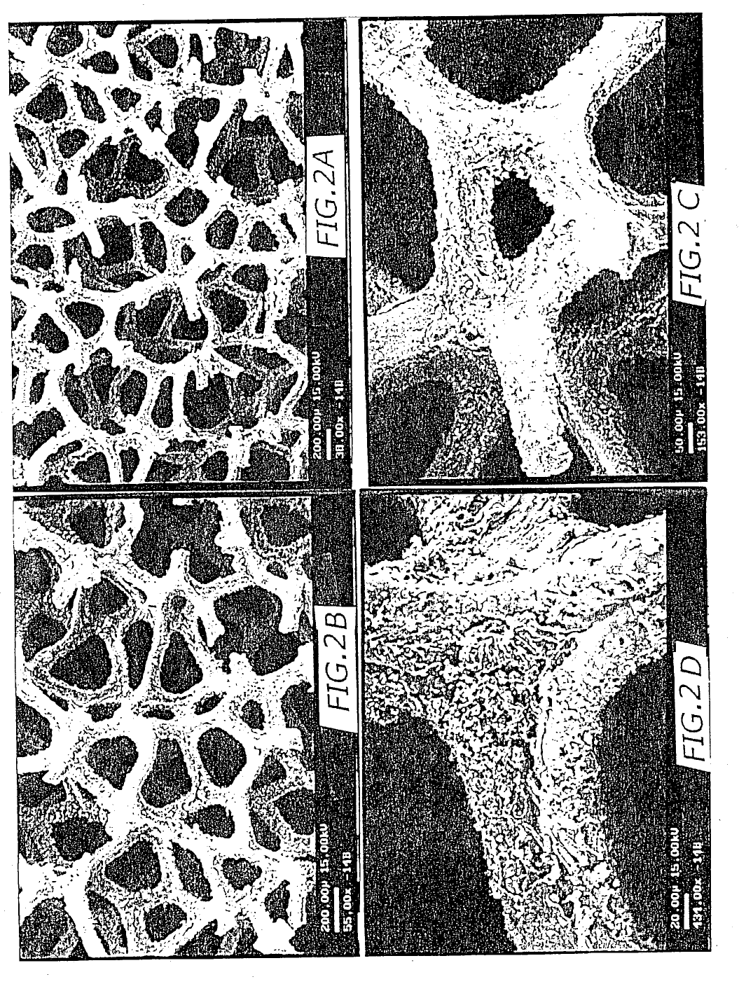

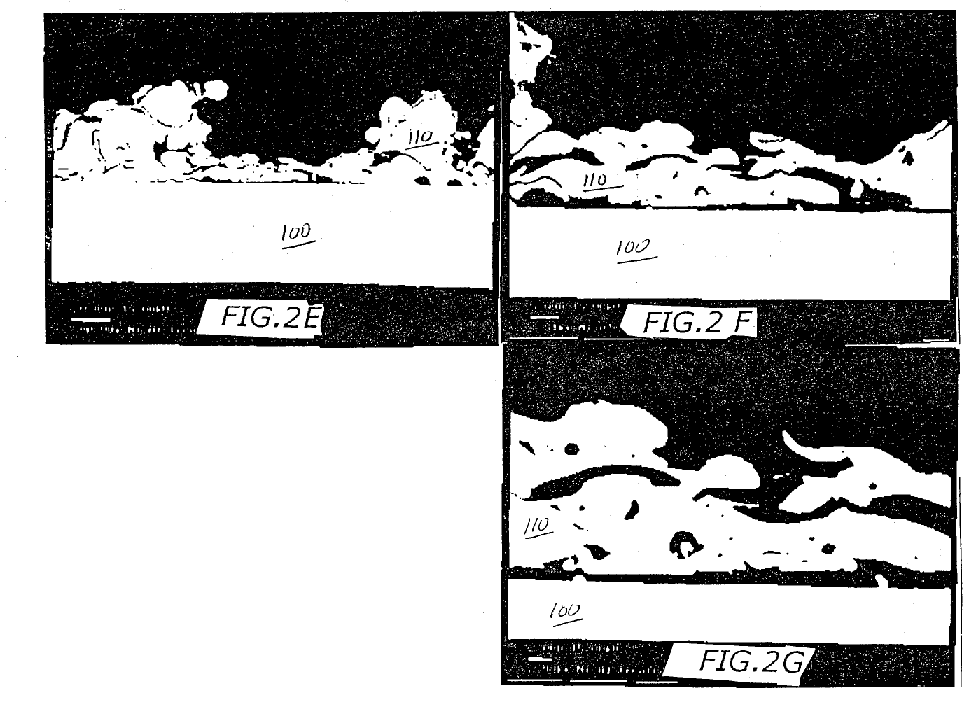

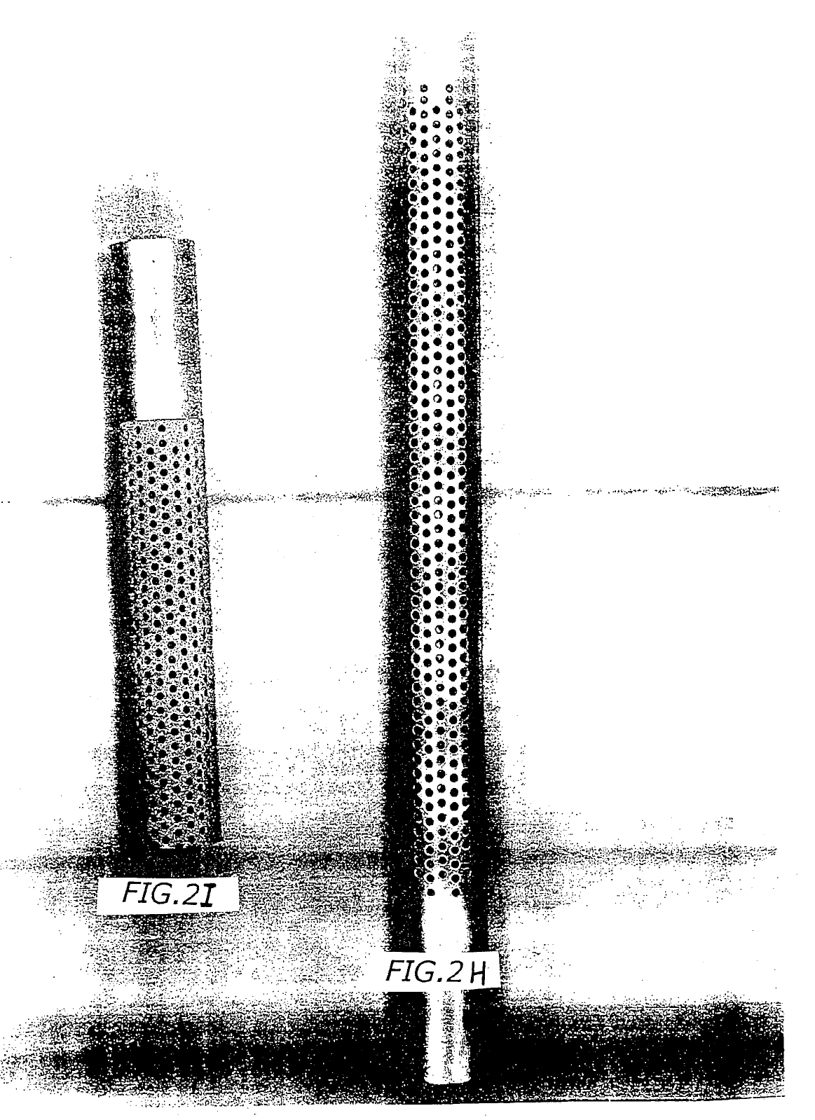

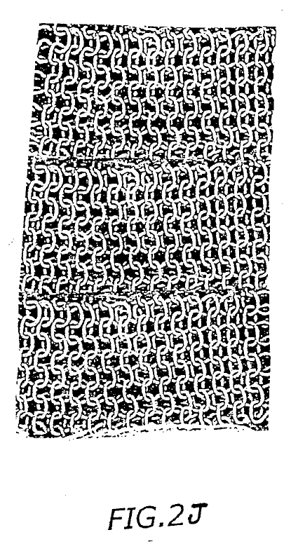

To illustrate the dramatic difference in the surface of an anchor layer applied in accordance with the present invention as compared to the surface of a metal substrate without the anchor layer, reference is made herein to FIGS. 1A through 1D and, for comparison thereto, FIGS. 2A through 2D. FIGS. 1A through 1D are photomicrographs of a foamed metal substrate taken at a variety of magnification levels. These Figures show that the substrate has a three-dimensional web-like structure having smooth surfaces. By comparison, FIGS. 2A through 2D are photomicrographs of a foamed metal substrate taken at corresponding magnification levels after an anchor layer has been electric arc sprayed thereon. A visual comparison of FIGS. 1A through 1D and the corresponding FIGS. 2A through 2D illustrates the roughened surface that results from electric arc spraying an anchor layer onto a substrate as taught herein. FIGS. 2E, 2F and 2G show sections of a high temperature steel plate substrate 100 and a nickel aluminide anchor layer 110 electric arc sprayed thereon, at magnifications of 500×, 1.51 k× and 2.98 k×, respectively. As is evident from these Figures, the anchor layer 110 provides a highly irregular surface on the substrate 100. Accordingly, the anchor layer 110 effectively increases the surface area on which catalytic material may be deposited on the carrier relative to a non-sprayed substrate and it provides structural features such as crevices, nooks, etc., that help prevent spalling of catalytic material from the anchor layer. FIGS. 2E through 2G illustrate that the relatively low temperature of the electric arc spray process deposits the metal feedstock for the anchor layer on the substrate at a temperature that permits the feedstock to freeze when it impinges upon the substrate rather than remaining molten and flowing into a smoother configuration.

Anchor layers of a variety of compositions can be deposited on a substrate in accordance with the present invention by utilizing, without limitation, feedstocks of the following metals and metal mixtures: Ni, Ni/Cr/Al/Y, Co/Cr/Al/Y, Fe/Cr/Al/Y, Co/Ni/Cr/Al/Y, Fe/Ni/Cr, Fe/Cr/Al, Ni/Cr, Ni/Al, 300 and 400 series stainless steels, Fe/Cr, and Co/Cr and, optionally, mixtures of one or more thereof. One specific example of a metal useful for wire arc spraying onto a substrate in accordance with the present invention is a nickel/aluminum alloy that generally contains at least about 90% nickel and from about 3% to 10% aluminum. Such an alloy may contain minor proportions of other metals referred to herein as “impurities”, for a total of not more than about 2% of the alloy. Some such impurities may be included in the alloy for various purposes, e.g., as processing aids to facilitate the wire arc spraying process or the formation of the anchor layer, or to provide the anchor layer with favorable properties.

The bond between a metal substrate and an anchor layer electric arc sprayed thereon is generally so strong that the sprayed substrate can be manipulated after the anchor layer is applied, or even after the catalytic material is applied onto the anchor layer. In either case, the strong bond between the anchor layer and the substrate prevents the spalling or flaking of the anchor layer and the catalyst material thereon from the substrate. In one example of the practice of the present invention, a perforated stainless steel tube substrate as shown in FIG. 2H was electric arc sprayed with a nickel aluminide feedstock to deposit an anchor layer thereon; a catalytic material can then be deposited on the anchor layer. A sample of a resulting catalyst member is shown in FIG. 2I. The anchor layer will provide superior adhesion of a catalytic material to the carrier when it is used to prepare a catalyst member in accordance with the present invention. A catalyst member so configured is suitable for use in an exhaust treatment apparatus to serve, for example, as a substitute for other generally cylindrical catalyst members that are commercially available for this use and that are sometimes referred to as “hot tubes”, a commercially recognized designation which Degussa Corporation is believed to claim as a trademark.

The strong bond of an anchor layer achieved by electric arc spraying permits the resulting substrates to be mechanically processed in various ways, e.g., they can be bent, compressed, folded, cut, woven, etc., after the anchor layer is deposited thereon, to compose a flow-through catalyst member. For example, a wire arc-sprayed foil substrate can be corrugated and rolled to provide a corrugated foil honeycomb as described below without significant loss of the anchor layer thereon. Similarly, a wire substrate coated in accordance with this invention can be wound or woven into a desired configuration, as seen in FIG. 2J, after having the anchor layer sprayed thereon, or it can be woven with other wires to compose a mesh that is used as a carrier for a catalytic material. For example, a metal mesh substrate having an anchor layer deposited thereon may be processed by being bent into a desired configuration, e.g., into a cylinder or into a corrugated sheet that may optionally be combined with other substrates to compose a carrier, or that may be used alone. Likewise, foamed metal having an anchor layer thereon may be processed by being compressed to change its shape and/or density as discussed herein. These processing steps may occur before or after the catalytic material is deposited on the substrate. Malleable substrates having an anchor layer sprayed thereon can be bent, folded, rolled, etc., into any desired configuration, including, for example, a cylindrical or tubular configuration suitable for positioning in the exhaust treatment apparatus of a small engine. Catalyst members comprising catalytic material deposited on such substrates of the present invention thus provide a novel method for producing substitutes for hot tubes.

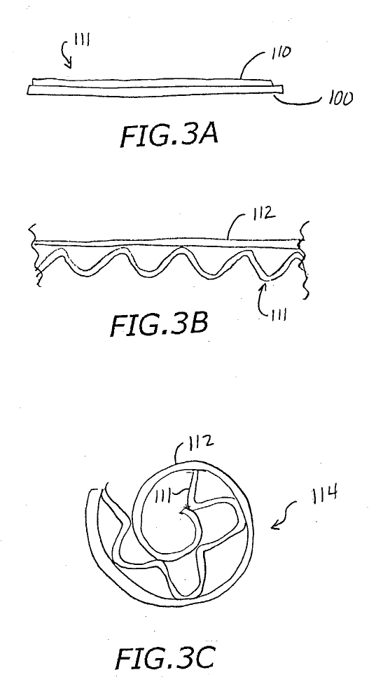

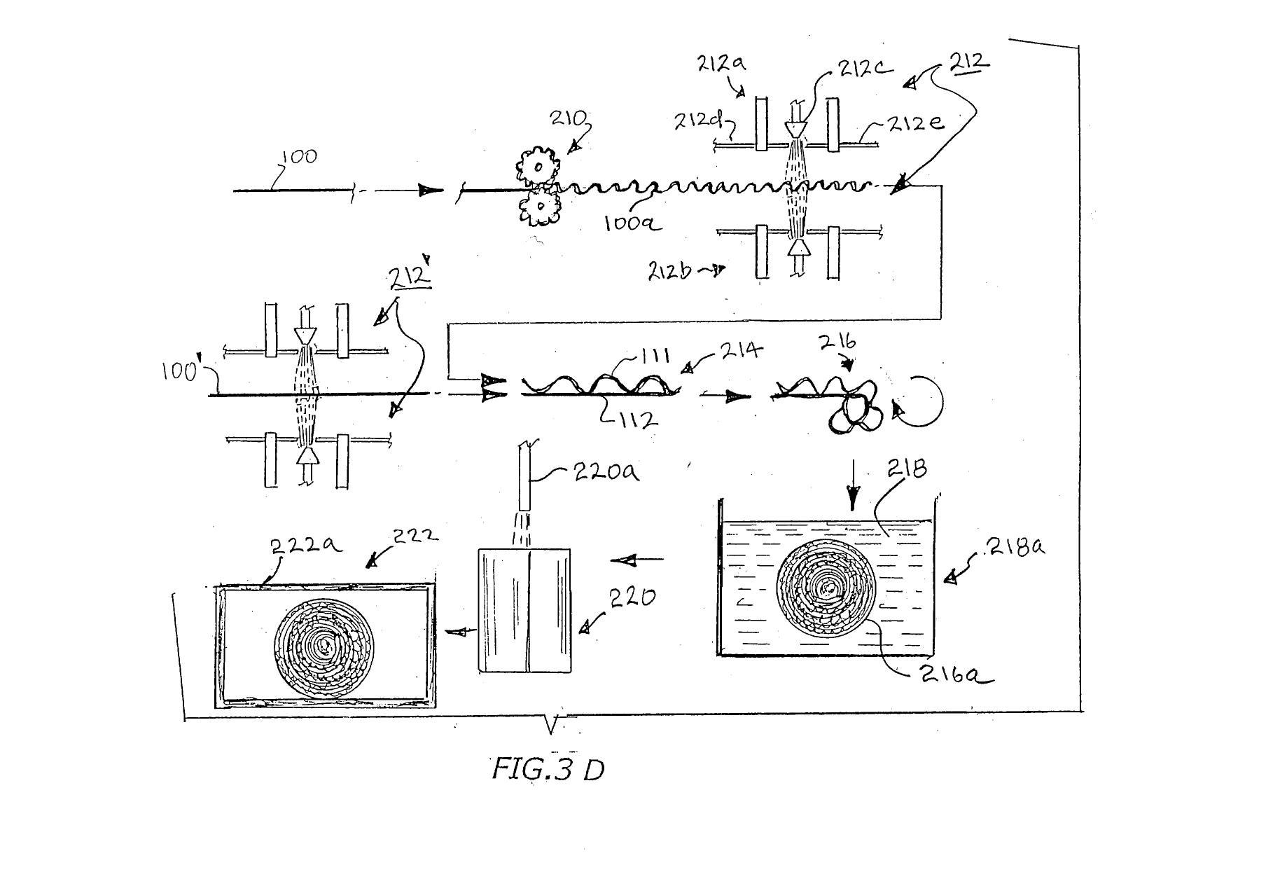

A metal substrate 100, seen in FIG. 3A, has been wire arc sprayed to deposit an anchor layer 110 thereon. The sprayed substrate 111 may then be corrugated and placed against a second, optionally sprayed substrate 112, as shown in FIG. 3B. The two substrates may be further processed by coiling them together as shown FIG. 3C to compose a carrier 114 for catalytic material to be deposited thereon. The process for producing a catalyst member from such a carrier is shown in schematically in FIG. 3D.

The process shown in FIG. 3D begins with the metal substrate 100 which is passed through a corrugation station 210 to produce a corrugated foil honeycomb substrate 100a. The corrugated substrate 100a is passed through an electric arc spraying station 212 comprising two electric arc spraying apparatuses 212a, 212b, one for spraying each side of substrate 100a. Each apparatus comprises a pair of electrified feedstock wires 212d and 212e which may comprise a nickel aluminide alloy or other metal, and a spray gun 212c for atomizing the molten metal formed by the electric charge passing between the electrode wires. The spray gun sprays the molten metal feedstock onto the substrate. Separately, a flat substrate 100′ has an anchor layer electric arc sprayed on both sides thereof in station 212′. The corrugated, electric arc sprayed substrate 111 is disposed upon the flat electric arc sprayed substrate 112 in step 214, and the two substrates are wound together in step 216 to produce a metallic honeycomb carrier in a manner generally known in the art. At coating station 218, the carrier 216a is dipped in a bath 218a comprising a slurry of catalytic material. In step 220, an air knife 220a is used to blow excess catalytic material from the carrier. In a fixing step 222, the coated carrier is placed in an oven 222a where it is dried and optionally calcined to remove the liquid portion of the slurry and to bind the catalytic material onto the carrier, thus producing a catalyst member comprising catalytic material deposited upon an electric arc sprayed carrier substrate. The catalyst member may be incorporated into an exhaust gas treatment apparatus by being mounted in a body or canister for placement in the exhaust gas stream of an engine.

An anchor layer deposited as taught herein can provide rigidity to an excessively ductile or malleable metal substrate and a roughened surface on which a catalytic material may be deposited, and it can seal the surface of a metal substrate and thus protect the substrate against surface oxidation during use. The ability to tenaciously adhere a catalytic material to a metal substrate,as provided herein even permits the structural modification of a catalyst member as required to conform to the physical constraints imposed by canisters or other features of the exhaust gas treatment apparatus in which the catalyst member is mounted.

A suitable catalytic material for use on a carrier substrate prepared in accordance with this invention can be prepared by dispersing a compound and/or complex of any catalytically active component, e.g., one or more platinum group metal compounds or complexes, onto relatively inert bulk support material. As used herein, the term “compound”, as in “platinum group metal compound” means any compound, complex, or the like of a catalytically active component (or “catalytic component”) which, upon calcination or upon use of the catalyst, decomposes or otherwise converts to a catalytically active form, which is often, but not necessarily, an oxide. The compounds or complexes of one or more catalytic components may be dissolved or suspended in any liquid which will wet or impregnate the support material, which does not adversely react with other components of the catalytic material and which is capable of being removed from the catalyst by volatilization or decomposition upon heating and/or the application of a vacuum. Generally, both from the point of view of economics and environmental aspects, aqueous solutions of soluble compounds or complexes are preferred. For example, suitable water-soluble platinum group metal compounds are chloroplatinic acid, amine solubilized platinum hydroxide, rhodium chloride, rhodium nitrate, hexamine rhodium chloride, palladium nitrate or palladium chloride, etc. The compound-containing liquid is impregnated into the pores of the bulk support particles of the catalyst, and the impregnated material is dried and preferably calcined to remove the liquid and bind the platinum group metal into the support material. In some cases, the completion of removal of the liquid (which may be present as, e.g., water of crystallization) may not occur until the catalyst is placed into use and subjected to the high temperature exhaust gas. During the calcination step, or at least during the initial phase of use of the catalyst, such compounds are converted into a catalytically active form of the platinum group metal or a compound thereof. An analogous approach can be taken to incorporate the other components into the catalytic material. Optionally, the inert support materials may be omitted and the catalytic material may consist essentially of the catalytic component deposited directly on the sprayed carrier substrate by conventional methods.

Suitable support materials for the catalytic component include alumina, silica, titania, silica-alumina, alumino-silicates, aluminum-zirconium oxide, aluminum-chromium oxide, etc. Such materials are preferably used in their high surface area forms. For example, gamma-alumina is preferred over alpha-alumina. It is known to stabilize high surface area support materials by impregnating the material with a stabilizer species. For example, gamma-alumina can be stabilized against thermal degradation by impregnating the material with a solution of a cerium compound and then calcining the impregnated material to remove the solvent and convert the cerium compound to a cerium oxide. The stabilizing species may be present in an amount of from about, e.g., 5 percent by weight of the support material. The catalytic materials are typically used in particulate form with particles in the micron-sized range, e.g., 10 to 20 microns in diameter, so that they can be formed into a slurry and coated onto a carrier member.

A typical catalytic material for use on a catalyst member for a small engine, e.g., for a hot tube-type device, comprises platinum, palladium and rhodium dispersed on an alumina and further comprises oxides of neodymium, strontium, lanthanum, barium and zirconium. Some suitable catalysts are described in U.S. patent application No. 08/761,544 filed Dec. 6, 1996, the disclosure of which is incorporated herein by reference. In one embodiment described therein, a catalytic material comprises a first refractory component and at least one first platinum group component, preferably a first palladium component and optionally, at least one first platinum group metal component other than palladium, an oxygen storage component which is preferably in intimate contact with the platinum group metal component in the first layer. These may also be a first zirconium component, at least one first alkaline earth metal component, and at least one first rare earth metal component selected from the group consisting of lanthanum metal components and neodymium metal components. The catalytic material may also contain at least one alkaline earth metal component and at least one rare earth component and, optionally, at least one additional platinum group metal component preferably selected from the group consisting of platinum, rhodium, ruthenium, and iridium components with preferred additional first layer platinum group metal components being selected from the group consisting of platinum and rhodium and mixtures thereof.

A particular catalytic material described therein comprises from about 0.3 to about 3.0 parts (e.g., grams per unit volume) of at least one palladium component; from 0 to about 2.0 parts of at least one first platinum and/or first rhodium component; from about 100 to about 2,000 parts of a first support; from about 50 to about 1000 parts of the total of the first oxygen storage components in the first layer; from 0.0 and preferably about 0.1 to about 10 parts of at least one first alkaline earth metal component; from 0.0 and preferably about 0.1 to about 300 parts of a first zirconium component; and from 0.0 and preferably about 0.1 to about 200 parts of at least one first rare earth metal component selected from the group consisting of ceria metal components, lanthanum metal components and neodymium metal component. Other suitable catalytic materials are described in U.S. Pat. No. 5,597,771, the disclosure of which is incorporated herein by reference.

Other methods known in the art for applying a catalytic material onto a carrier can also be used with the present invention including, for example, chemical vapor deposition.

As indicated above, one type of substrate with which the present invention can be employed is a metallic foam substrate (sometimes referred to herein as “foamed metal”). Methods for making foamed metal are known in the art, as evidenced by U.S. Pat. No. 3,111,396, discussed above, and the use of foamed metal as a carrier for a catalytic material has been suggested in the art, as recognized above by reference to SAE Technical Paper 971032 and to the journal article by Pestryakov et al. One aspect of the present invention provides that the foamed metal substrate may comprise regions of varying substrate density and therefore provide, within a specified unit volume, different surface areas on which catalytic material can be deposited, i.e., different “surface area densities”. Foamed metal substrates having uniform densities are referred to herein as “single density foamed substrates” whereas substrates having regions of differing densities are referred to herein as “multiple density foamed substrates”. It is known in the art that the density of a single density foamed substrate can be manipulated by varying its organic precursors. Alternatively, however, a foamed metal substrate may be ductile and may be compressed after it is formed. Electric arc spraying in accordance with this invention makes feasible compressing the foam after it is coated with an anchor layer, and even after the catalytic component is applied thereto.

It has not previously been recognized in the prior art that a given procedure for depositing catalytic material on a multiple density foamed substrate will deposit different effective loadings of catalytic materials in the regions of differing density. A multiple density foamed substrate may be formed as an integral structure, e.g., by compressing only a portion of the structure, or it may be provided by disposing two or more separate integral foamed metal structures having the same catalytic materials thereon but being of different densities and in close proximity to each other in the same apparatus, i.e., in an effectively contiguous relationship to each other, so that gas that is forced to flow through one substrate will enter the other. The contiguous placement of catalyst members having substrates of different substrate densities in accordance with the present invention can be practiced with substrates other than foamed metal substrates. For one example, this aspect of the present invention can be practiced using carrier substrates comprising corrugated foils and/or screens, and/or combinations thereof.

Catalyst members prepared in accordance with the present invention can be used in a wide variety of applications in which a fluid stream is flowed through the catalyst member to make contact with the catalytic material therein. An important use for such a catalyst member is as a flow-through catalyst member for the catalytic treatment of the components of a fluid stream, e.g., for the catalytic conversion of the noxious components of engine exhausts including, without limitation, exhausts from internal combustion engines, e.g., spark-ignited gasoline-type engines, compression-ignited diesel-type engines, etc. Such exhausts may comprise one or more of unburned hydrocarbons, carbon monoxide (CO), oxides of nitrogen (NOₓ), soluble oil fractions, soot, etc., which are to be converted by the catalytic material into innocuous substances. For example, the invention may be practiced in EGR lube catalysts for the removal of the soluble oil fraction (SOF) from diesel soot. Other applications include catalytic filters for car cabin air, reusable home heating air filters, catalytic flame arrestors and municipal catalytic water filtration units. In such applications, it is considered advantageous to provide a carrier of high surface area, to enhance contact between the fluid stream and the catalyst member. For fluid phase reactions, a suitable carrier typically has a plurality of fluid-flow passages extending therethrough from one face of the carrier to another for fluid-flow therethrough. In one conventional carrier configuration that is commonly used for gas phase reactions and is known as a “honeycomb”, the passages are typically essentially (but not necessarily) straight from an inlet face to an outlet face of the carrier and are defined by walls on which the catalytic material is coated so that the gases flowing through the passages contact the catalytic material. The flow passages of the carrier member may be thin-walled channels which can be of any suitable cross-sectional shape and size such as trapezoidal, rectangular, square, sinusoidal, hexagonal, oval, or circular. Such structures may contain from about 60 to about 700 or more gas inlet openings (“cells”) per square inch of cross section (“cpsi”), more typically 200 to 400 cpsi. Such a honeycomb-type carrier may be constructed from metallic substrates in various ways such as, e.g., by placing a corrugated metal sheet on a flat metal sheet and winding the two sheets together about a mandrel. Alternatively, they may be made of any suitable refractory materials such as cordierite, cordierite-alpha-alumina, silicon nitride, zirconium mullite, spodumene, alumina-silica magnesia, zirconium silicate, sillimanite, magnesium silicates, zirconium oxide, petallite, alpha-alumina and alumino-silicates. Typically, such materials are extruded into a honeycomb configuration and then calcined, thus forming passages defined by smooth interior cell walls and a smooth outer surface or “skin.” The wire arc spraying technique of the present invention can be used to apply an anchor layer to the smooth interior surfaces of the gas-flow passages formed in a honeycomb-type ceramic carrier, as well as on the front face thereof, to provide a superior surface on which to deposit catalytic material and to increase the turbulence of the gas flowing through the catalyst member and thus increase the catalytic activity. In addition, the anchor layer may be deposited on the smooth exterior surface of the substrate to facilitate mounting the substrate in a canister, as described herein. Other flow-through-type carriers are known as well, e.g., porous foamed metal, wire mesh, etc., in which cases the gas-flow passages may be non-linear, irregular or reticulated. In many such embodiments, the inlet and outlet faces of the carrier are defined simply as the surfaces through which the fluid enters or leaves the carrier, respectively. A flow-through catalyst member is typically mounted in a body such as a canister to guide fluid flow through the carrier.

A variety of deposition methods other than electric wire arc spraying are known in the art to deposit a discrete coating of catalytic material on the electric arc sprayed carrier substrate. These include, for example, disposing the catalytic material in a liquid vehicle to form a slurry and wetting the carrier substrate with the slurry by dipping the carrier into the slurry, spraying the slurry onto the carrier, etc, Alternatively, the catalytic material may be dissolved in a solvent and the solvent may then be wetted onto the surface of the carrier substrate and thereafter removed to leave the catalytic material, or a precursor thereof, on the carrier substrate. The removal procedure may entail heating the wetted carrier and/or subjecting the wetted carrier to a vacuum to remove the solvent via evaporation. Another method for depositing a catalytic material onto the carrier is to provide the catalytic material in powder form and adhere it to the substrate via electrostatic deposition. This method would be appropriate for producing a catalyst member for use in liquid phase chemical reactions. These methods of applying the catalytic component onto the carrier constitute a separate step in the manufacturing process relative to the application of the anchor layer, and their use therefore provides a distinction to the teaching of U.S. Pat. No. 5,204,302 (discussed above) in which the same plasma spray process for applying an undercoat is used to apply the catalyst. This process can be described as electric arc spraying on anchor layer on a substrate, discontinuing the spraying of that substrate and then depositing a catalytic material thereon.

When deposited onto a honeycomb or other flow-through-type carrier, the amounts of the various catalytic components of the catalytic material are often presented based on grams per volume basis, e.g., grams per cubic foot (g/ft³) for platinum group metal components and grams per cubic inch (g/in³) for catalyst member as a whole, as these measures accommodate different gas-flow passage configurations in different carriers. Catalyst members suitable for use in the treatment of engine exhaust gases may comprise a platinum group metal component loading of 25.5 g/ft³ with a weight ratio of platinum-to-rhodium of 5:1, although these specifications may be varied considerably according to design and performance requirements. The finished catalyst member may be mounted in a metallic canister that defines a gas inlet and a gas outlet and that facilitates mounting the catalyst member in the exhaust pipe of the engine.

Catalyst members of this invention are well-suited for use in the treatment of the exhaust of small engines, especially two-stroke and four-stroke engines, because of the superior adherence of the catalytic material to the substrate. The exhaust gas treatment apparatus associated with a small engine is subjected to significantly different operating conditions from those experienced by the catalytic converters for automobiles or other large engine machines. This is because the devices with which smaller engines are powered are commensurately smaller than those powered by larger engines, e.g., a typical use for a small engine is to drive a lawn mower, whereas a larger engine will power an automobile. Small engines are also employed in motorcycles, motor bikes, snow mobiles, jet skis, chain saws, snow blowers, grass blowers, lawn edgers, etc. Such smaller devices are less able to absorb and diffuse the vibrations caused by the engine, and they provide less design flexibility with regard to the placement of the catalytic converter. Because of the close proximity of the catalytic converter to a small engine, the catalyst member is subjected to intense vibrations. In addition, although the small mass of the engine allows for rapid cooling of the exhaust gases, small engines are characterized by high temperature variations as the load on the engine increases and decreases. Accordingly, a catalyst member used to treat the exhaust of a small engine is typically subjected to greater thermal variation and more vibration than the catalytic converter on an automobile, and these conditions have lead to spalling of catalytic material from prior art catalyst members.

Due to their superior durability, catalyst members according to the present invention can also be used to treat the exhaust of a larger engine in ways unsuitable for many prior art catalyst members. For example, whereas a conventional catalyst member is disposed well downstream of an engine in a so-called underfloor position at which exhaust temperatures and engine vibrations are diminished, a catalyst member according to the present invention can be used advantageously in a close-coupled position relative to a vehicle engine. A close-coupled position is one that is much closer to the engine than the underfloor position and is typically in the engine compartment rather than under the sedan floor. A close-coupled position may be within inches from the exhaust manifold, or adjacent to it. The present invention permits close positioning of this kind relative to the engine where prior art catalyst members would not be placed due to concern that the intense heat and vibration from the engine could cause physical failure of the catalyst member, e.g., spalling of the catalytic material therefrom. The positioning of a catalyst member according to the present invention is, accordingly, more significantly dictated by the limits on the high temperature durability of the catalytic material rather than the physical integrity of the catalyst member. Spalling of catalytic material from prior art catalyst members is exacerbated with metallic carriers that may flex or bend under stress. Accordingly, the present invention is especially advantageous in these applications because of the superior adherence it provides between the catalytic material and the carrier as a result of the electric arc sprayed anchor layer on the metallic substrate.

As mentioned above, a variety of metal substrates can be wire arc-sprayed with metallic feedstock to deposit an anchor layer thereon. Accordingly, the anchor layer can be formed on various components the engine and/or of the associated exhaust gas treatment apparatus. For example, an anchor layer may be deposited on the interior of a metallic exhaust gas manifold to support a catalytic material therein. Alternatively, piston crowns may be wire arc spray-coated to provide an anchor layer for a catalytic material to be deposited thereon.

Still another aspect of the invention pertains to the use of thermal spraying to adhere one substrate to another. For example, the wire arc spray process can be directed to a ceramic body substrate on which a porous mesh or metal sheet substrate (preferably perforated) has been disposed, so that the anchor layer serves to bond the two substrates together. Thus, a metal sheet mounting substrate defining mounting tabs can be securely attached to a ceramic catalyst member to facilitate mounting the catalyst member in a metal canister as an alternative to using costly ceramic fiber fabric mounting mats. The use of a metallic mounting substrate surrounding the ceramic catalyst member is advantageous in that the metallic mounting member will have a coefficient of thermal expansion closer to that of the surrounding metallic canister than the ceramic monolith or a typical ceramic fiber fabric mounting mat. Intumescent ceramic fiber fabrics have been used in mounting mats for ceramic catalyst members in metal canisters to ameliorate the differences in thermal expansion of the canister and the catalyst member, but such fabrics are expensive and are subject to degradation under normal operating conditions. A metallic mounting substrate would be more durable, less expensive and better suited than a ceramic fiber fabric for securing the catalyst member to the canister because it can be formed to provide mounting tabs by which the catalyst member can be riveted, welded, soldered, etc., to the metallic canister. Even if it desired to continue the use of ceramic fiber fabric mounting mats, the rough surface of the anchor layer deposited by the electric arc spraying method of the present invention can be used advantageously to deposit a rough, adherent gripping region on the otherwise smooth exterior of the ceramic catalyst member so that the catalyst member will be more securely mounted within the surrounding ceramic fiber fabric.

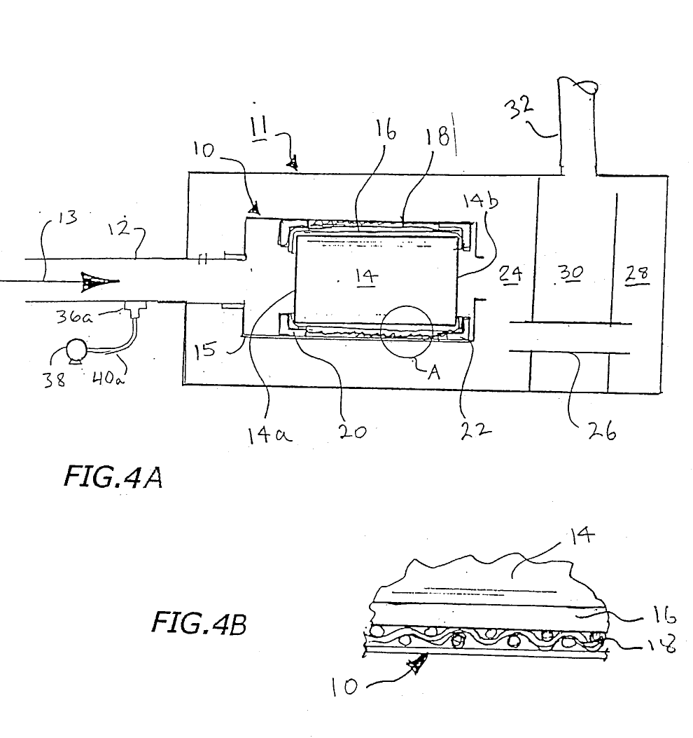

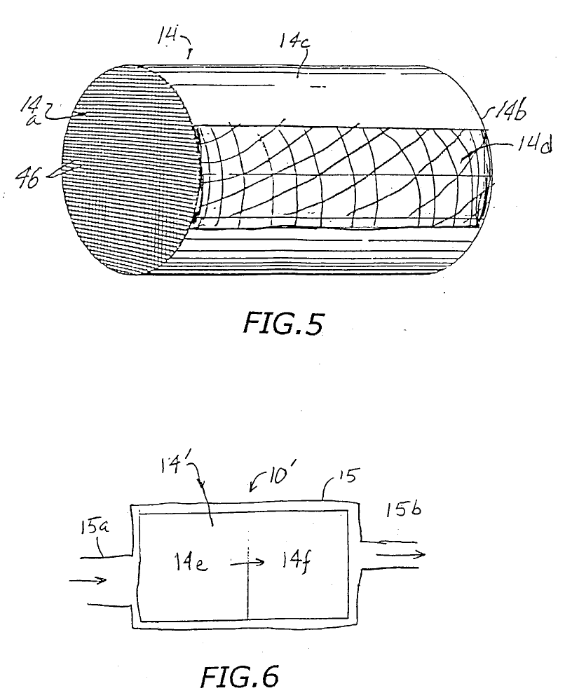

An exhaust gas treatment apparatus comprising a catalyst member in accordance with the present invention connected in the exhaust flow path is shown schematically in FIGS. 4A and 4B. Apparatus 10, which is situated in muffler 11, comprises a canister 15 mounted on the end of an exhaust pipe 12 which collects exhaust gas flowing, as indicated by arrow 13, from the exhaust outlet of a small engine (not shown). Canister 15 is a clamshell-type canister which contains a catalyst member 14 mounted therein. Surrounding catalyst member 14 within canister 15 is a layer of ceramic fiber fabric 16 which serves as a mounting mat, as is known in the art. Catalyst member 14 is shown in greater detail in FIG. 5 where it is seen that catalyst member 14 comprises an extruded ceramic honeycomb-type carrier defining a plurality of longitudinally-extending gas-flow passages 46 that extend between an inlet face 14a and outlet face 14b. Catalyst member 14 has a smooth exterior skin 14c. Catalyst member 14 has been wire arc-sprayed in accordance with the present invention to provide an anchor region 14d on the outer skin 14c thereof. The anchor region 14d is strongly adhered to the ceramic monolith and provides a region of improved gripping contact with the ceramic fiber fabric 16. In addition, the ceramic monolith was sprayed from at least one of inlet face 14a and outlet face 14b to increase the surface area within the gas-flow passages on which catalytic material may be deposited. In addition, the inlet and outlet faces of the catalyst member are roughened by the anchor layer deposited thereon, as are the gas-flow passages, so that all of these surfaces tend to disrupt laminar gas flow through the catalyst member. Surrounding ceramic fiber fabric 16 is an optional wire mesh 18. Fabric 16 and wire mesh 18 are wrapped around the sides of catalyst member 14 and are folded over ends 14a, 14b of catalyst member 14. Optional annular end rings 20 and 22 are welded to canister 15 to apply axial pressure on ends 14a and 14b of catalyst member 14 and help to secure catalyst member 14 within canister 15. In alternative embodiments, canister 15 can be configured to form end rings as an integral part of the canister. Apparatus 10 further comprises optional air inlets 36a through which optional air pump 38 may inject air or another oxygen-containing gas into the exhaust gas stream via air injection lines 40a. Muffler 11 vents to an exhaust pipe 32. In operation, exhaust gases flow through exhaust pipe 12 into canister 15 of apparatus 10. The gases flow through catalyst member 14 and enter first chamber 24 of muffler 11. As gases flow through catalyst member 14, the catalytic material therein stimulates the conversion of some of the hydrocarbons and carbon monoxide in the exhaust gas to innocuous substances, e.g., carbon dioxide and water. The gases then flow through conduit 26 to second chamber 28 and then to third chamber 30. Gases are vented from muffler 11 to pipe 32. Thus, apparatus 10 defines a flow path from pipe 12 to pipe 32, through catalyst member 14.

In an alternative embodiment, catalyst member 14 may be formed from any one or more of the metallic substrates described above, e.g., corrugated, rolled sheet metal, metal foil, wire mesh, foamed metal, etc. In one particular embodiment illustrated in FIG. 6, catalyst member 14′ comprises a catalytic material deposited by the same procedure on foamed metal portions 14e and 14f having different densities. As a result, the loading of catalytic material in region 14e is different from that in region 14f. As indicated above, region 14e and region 14f may each comprise a single density foamed substrate, one having a density different from the other. As a result, the loading of catalytic components deposited thereon in similar processes are likely to be different. By placing the two regions in close proximity to each other in the canister, exhaust gas flows from one to the other. Alternatively, catalyst member 14′ may comprise an originally single density foamed substrate that is compressed in one of regions 14e and 14f to create regions of different density. Canister 15 guides exhaust gas first into an inlet face of region 14e, then into region 14f and out the outlet face of region 14f and then out the outlet 15b of the canister, as indicated by the arrows. As stated above, this invention encompasses embodiments in which other structures carry an anchor layer with catalytic material thereon. For example, the interior of metal pipe 12 may be electric arc sprayed to deposit an anchor layer thereon and have catalytic material deposited thereon as one embodiment of this invention.

### EXAMPLE 1

Six steel wire mesh substrates and a 100 cpsi metal honeycomb were each wire arc-sprayed using nickel aluminide wire as the anchor layer feedstock. The nickel aluminide wire had a diameter of 1/16 inch (1.59 millimeters (mm)). The molten nickel aluminide alloy was sprayed at 11 lbs/hr with a gas pressure of 70 psi to deposit an anchor layer on the substrates. The spraying process on the 100 cpsi monolith successfully deposited an anchor coat in the interior gas-flow passages of the monolith.

One of the wire mesh substrates was subjected to temperature cycles in air at from about 100° C. to 1000° C. for 15 hours. After the temperature cycling, the mesh was examined and compared to a reference, and no difference between the surfaces of the two samples was noticed. A second wire mesh substrate was cycled for three hours from room temperature to about 930° C. by heating in the flame of a Bunsen burner for about 6 seconds per cycle. Again, upon comparison to a reference, no difference in the surface of the anchor layers was seen. Catalytic material was applied to each of the samples and excellent adhesion was seen in all cases.

### EXAMPLE 2

Three different catalyst members were prepared in tubular configurations suitable for use in the exhaust treatment apparatus of a small engine to function as hot tubes in accordance with the present invention, as follows. First, a steel metal screen was wire arc spray-coated with a nickel-aluminide alloy as described in Example 1 to deposit an anchor layer on the substrate. The screen substrate was then coated with a catalytic material comprising around 1 to 3 weight percent platinum and rhodium, in a 5:1 weight ratio, as the principal catalytic species, at a loading of 0.31 grams per square inch of substrate (g/in²). The screen was then rolled into a tube having a diameter of about 1.75 inch and a length of about 7.25 inches, and it was tack-welded at three points along the seam to hold it together. This configuration had about 69 square inches of surface area on each side of the tube, for a total of 138 square inches.

Second, a metal herringbone foil was wire arc-sprayed with nickel aluminide alloy as described in Example 1 to provide an anchor layer thereon. The sprayed foil substrate was then coated with the same catalytic material as described above at a washcoat loading of 0.167 g/in². The foil was cut to measure 6 inches wide by 23 inches long, thus providing a surface area of about 138 square inches on each side. The foil was rolled into a tube having an outer diameter of 2 inches and a length of 6 inches.

The sprayed mesh substrates of Example 1 were each coated with the catalytic material referred to above. The substrates were open and porous so the surface area is difficult to quantify.

Each of the foregoing catalyst members was mounted in an exhaust tube measuring 7.75 inches in length and having an inner diameter of 2.375 inches to form a hot tube. Each hot tube was connected to the exhaust of a 50 cc, two-stroke engine with secondary air injected into the exhaust at a rate of 10 liters per minute. The effectiveness of the various hot tubes was tested by sampling the exhaust gas twice at a point upstream of the catalyst member and twice at a point downstream of the hot tube with the engine running under a variety of operating conditions or modes. For each measurement, the engine was run for 3 minutes at the given operating mode. The data from the upstream and downstream samples were averaged and the averages were used to calculate conversion rates for the respective catalyst members in the hot tubes. Measurements were made on an empty tube to provide a baseline comparison.

Each of the hot tubes exhibited significant conversion rates for hydrocarbons at temperatures of about 450° C. The hot tubes comprising the six wire mesh substrates of Example 1 had the best low temperature (200° to 325° C.) activity.

While the invention has been described in detail with reference to particular embodiments thereof, it will be apparent that upon a reading and understanding of the foregoing, numerous alterations to the described embodiments will occur to those of ordinary skill in the art and it is intended to include such alterations within the scope of the appended claims.

What is claimed is:

1. A catalyst member comprising:
a carrier substrate having an anchor layer disposed thereon by electric arc spraying; and
catalytic material disposed on the carrier substrate.

2. The catalyst member of claim 1 wherein the anchor layer is deposited by electric arc spraying a metal feedstock selected from the group consisting of nickel, Ni/Cr/Al/Y, Co/Cr/Al/Y, Fe/Cr/Al/Y, Co/Ni/Cr/Al/Y, Fe/Ni/Cr, Fe/Cr/Al, Ni/Cr, Ni/Al, 300 series stainless steels, 400 series stainless steels, Fe/Cr and Co/Cr, and mixtures of two or more thereof.

3. The catalyst member of claim 2 wherein the anchor layer comprises nickel and aluminum.

4. The catalyst member of claim 3 wherein the aluminum comprises from about 3 to 10 percent of the combined weights of nickel and aluminum in the anchor layer.

5. The catalyst member of claim 3 wherein the aluminum comprises from about 4 to 6 percent aluminum of the combined weights of nickel and aluminum in the anchor layer.

6. The catalyst member of claim 1 wherein the catalytic material is deposited on the anchor layer and comprises a refractory metal oxide support on which one or more catalytic metal components are dispersed.

7. An exhaust treatment apparatus comprising the catalyst member of claim 1, claim 3 or claim 4 connected in the exhaust flow path of an internal combustion engine.

8. The apparatus of claim 7 wherein the metal substrate comprises the interior surface of a conduit through which the exhaust of an internal combustion engine is flowed prior to discharge of the exhaust.

9. The apparatus of claim 7 wherein the carrier substrate comprises a metal substrate.

10. The apparatus of claim 7 wherein the carrier substrate comprises a ceramic substrate.

11. A catalyst member comprising:
a carrier substrate comprising at least two regions of different substrate densities disposed for fluid flow from one region to the other; and
a catalytic material deposited on the at least two substrate regions of different surface area densities.

12. The catalyst member of claim 11 wherein the at least two substrate regions of different substrate densities have thereon different effective loadings of the catalytic material.

13. The catalyst member of claim 11 or claim 12 wherein the at least two substrate regions comprise regions of substrates selected from the group consisting of foamed metal, wire mesh and corrugated foil honeycomb.

14. A catalyst member comprising:
an open carrier substrate having an anchor layer disposed thereon by thermal spraying; and
catalytic material disposed on the carrier.

15. A method for manufacturing a catalyst member comprising:
depositing by electric arc spraying a metal feedstock onto a substrate to provide a metal anchor layer on the substrate, and
depositing a catalytic material onto the substrate.

16. The method of claim 15 comprising depositing the catalytic material by means other than electric arc spraying.

17. The method of claim 16 wherein depositing the catalytic material comprises coating the metal anchor layer with a catalytic material comprising a refractory metal oxide support on which one or more catalytic components are dispersed.

18. The method of claim 15 comprising electric arc spraying a molten metal feedstock at a temperature that permits the molten metal to freeze into an irregular surface configuration upon impinging on the substrate surface.

19. The method of claim 18 comprising spraying the molten metal with an arc temperature of not more than about 10,000° F.

20. A method for manufacturing a catalyst member comprising:
electric arc spraying a metal feedstock onto at least one substrate to provide at least one anchor layer-coated substrate;
depositing onto the at least one anchor layer-coated substrate a catalytic material comprised of a bulk refractory metal oxide having dispersed thereon one or more catalytically active components to provide at least one catalyzed substrate; and
incorporating the at least one catalyzed substrate into a body configured to define an inlet opening and an outlet opening and so configuring and disposing the at least one catalyzed substrate between the inlet and outlet openings to define a plurality of fluid flow paths therebetween.

21. The method of any one of claims 15-20 wherein the anchor layer is deposited by electric arc spraying a metal feedstock selected from the group consisting of nickel, Ni/Cr/Al/Y, Co/Cr/Al/Y, Fe/Cr/Al/Y, Co/Ni/Cr/Al/Y, Fe/Ni/Cr, Fe/Cr/Al, Ni/Cr, Ni/Al, 300 series stainless steels, 400 series stainless steels, Fe/Cr and Co/Cr, and mixtures of two or more thereof.

22. The method of claim 21 wherein the aluminum comprises from about 3 to 10 percent of the combined weights of nickel and aluminum in the anchor layer.

23. The method of claim 21 wherein the aluminum comprises from about 4 to 6 percent of the combined weights of nickel and aluminum in the anchor layer.

24. The method of any one of claims 15 through 20 wherein the substrate comprises a ferritic steel foam.

25. The method of claim 24 wherein the metal feedstock is deposited by electric arc spraying a metal feedstock selected from the group consisting of nickel, Ni/Cr/Al/Y, Co/Cr/Al/Y, Fe/Cr/Al/Y, Co/Ni/Cr/Al/Y, Fe/Ni/Cr, Fe/Cr/Al, Ni/Cr, Ni/Al, 300 series stainless steels, 400 series stainless steels, Fe/Cr and Co/Cr, and mixtures of two or more thereof.

26. The method of claim 25 wherein the aluminum comprises from about 3 to 10 percent of the combined weights of nickel and aluminum in the anchor layer.

27. An exhaust treatment apparatus comprising:
a catalyzed substrate comprising a metal substrate defining a plurality of fluid flow passages therethrough and having thereon an anchor layer electric arc sprayed thereon and a catalytic material disposed on the anchor layer, the catalytic material comprising a bulk refractory metal oxide having dispersed thereon one or more catalytically active metal components; and
a canister having an inlet opening and an outlet opening and within which the catalyzed metal substrate is enclosed, the catalyzed metal substrate being disposed between the inlet and outlet openings, whereby at least some of a fluid flowing through the canister between the inlet and outlet openings thereof is constrained to follow the fluid flow paths and thereby contact the catalyzed metal substrate.

28. The catalyst member of claim 27 wherein the catalyzed metal substrate is configured and positioned within the canister whereby substantially all of a fluid flowing through the canister between the inlet and outlet openings thereof is constrained to follow the fluid flow paths and thereby contact the catalyzed metal substrate.

29. A method for treating the exhaust stream from an engine, comprising flowing the exhaust stream into contact with the catalyst member of claim 1 or claim 11.
